(19) United States
(12) Patent Application Publication
(10) Pub. No.: US 2008/0153427 A1
(43) Pub. Date: Jun. 26, 2008

(54) Data Processing Apparatus and a Method of Operating Data Processing Apparatus for Setting a State of a User Application

(75) Inventors: Kevin Michael O'Shaughnessy, Galway (IE); Ivo Ruben Willem Jager, Dublin (IE)

Correspondence Address: FENWICK & WEST LLP, SILICON VALLEY CENTER, 801 CALIFORNIA STREET, MOUNTAIN VIEW, CA, 94041, US

(73) Assignee: Palm, Inc., Sunnyvale, CA (US)

(21) Appl. No.: 11/615,792

(22) Filed: Dec. 22, 2006

(51) Int. Cl. H04B 7/00

(52) U.S. Cl. 455/69

(57) ABSTRACT

A data processing apparatus (200), comprising a processor (204), a memory (202) and a user interface (210) is described. The data processing apparatus is configured to present to a user via the user interface a plurality of options indicative of a different state a user application operative on the data processing apparatus can have. The data processing apparatus is configured to receive via the user interface a user selection of a one of the plurality of options and to respond to a user selection to establish a user identity in the user application and to automatically set the state of said user application in accordance with the selected option.

### CROSS REFERENCE TO RELATED APPLICATIONS

This application is related to U.S. patent application Ser. No. ______ (Attorney Docket No. 24772-12399), filed Dec. 22, 2006, and titled “Data Processing Apparatus and a Method of Operating Data Processing Apparatus for Generating Representations of Availability Status for Application Programs”, having inventors Kevin Michael O'Shaughnessy and Ivo Ruben Willem Jager, and assigned to the same entity as the present application, the contents of which is hereby incorporated by reference.

This application is related to U.S. patent application Ser. No. ______ (Attorney Docket No. 24772-12415), filed Dec. 22, 2006, and titled “A Terminating Device and a Method of Operating a Terminating Device Configured to Communicate Availability Status Directly Between Terminating Devices”, having inventors Kevin Michael O'Shaughnessy and Ivo Ruben Willem Jager, and assigned to the same entity as the present application, the contents of which is hereby incorporated by reference.

This application is related to U.S. patent application Ser. No. ______ (Attorney Docket No. 24772-12416), filed Dec. 22, 2006, and titled “A Presence Engine and Method of Operating a Presence Engine for Encoding or Decoding Availability Status Into a Signal Representative of an Audio Signal”, having inventors Kevin Michael O'Shaughnessy and Ivo Ruben Willem Jager, and assigned to the same entity as the present application, the contents of which is hereby incorporated by reference.

### BACKGROUND

1. Field of Art

The disclosure relates to data processing apparatus and a method of operating data processing apparatus, for example, mobile communications devices that utilize communications availability status.

2. Description of the Related Art

Communications applications are known that take a predetermined action dependent upon the communications availability status that has been recorded for a terminating device in a communications network. Examples of such communications applications include instant messaging and push to talk (PTT) applications.

PTT applications are known to be used on mobile telephones and the like. The push to talk application provides a two-way radio having a bi-directional radio transceiver operating as a half-duplex channel in which only one unit transmits at a time, and any number of units can listen. Such a service allows a user of the mobile telephone to instantly reach users of other mobile telephones whilst eliminating the dialing and ringing steps that are required when making a regular cellular telephone call. Such operation is sometimes known as a “walkie-talkie” service.

In order to set up a PTT call, a user need only select the one or more contacts with which they wish to participate in a PTT call, and as long as those contacts are available, the user can hold down a PTT button on their mobile phone and speak into the microphone of their mobile phone. Each participant in the PTT call can then hear the initial user on their speaker. Once the initial user has released their PTT button any of the other participants in the PTT call can press their PTT button so that they can speak to the other participants in the call. During a PTT call it is only possible for one participant in the call to transmit at any one time. When no one is transmitting, the first person to press their PTT key is allocated the right to transmit by the PTT system. Having the right to transmit is known as “having the floor.”

In order to provide an indication to the PTT system and other users regarding whether a user of a push to talk application is available or not, a user records a presence status associated with themselves from a predetermined list of presence status options. The recorded presence status of the user is displayed to other users of push to talk applications on their mobile telephones. This enables users of a push to talk application to view the presence status of their contacts before deciding whether or not they wish to attempt to set up a PTT call with them.

Furthermore, a push to talk application and/or a push to talk server associated with the application, can take a predetermined action based upon a contact's presence status when a user tries to set up a PTT call with that contact. For example, if a contact's presence status is recorded as “available,” a push to talk call will be set up automatically. However, if the contact's presence status is recorded as “do not disturb,” a push to talk call will be automatically rejected. It is also possible for a contact to have a presence status of “silent,” in which case the contact will be prompted to provide an input as to whether or not they want to accept the push to talk call.

An example of a PTT application is provided by Cingular Wireless of Atlanta, Ga., USA. The PTT application resides on a cellular telephone and is activated by a user pressing a PTT key on the keypad of the telephone. When the PTT application is activated the telephone enters a default status for communications availability of “available.” That is to say, the telephone automatically signals to the cellular network that it is set to receive calls without any restrictions.

If a user of the telephone wishes to establish different communications availability they have to initiate an availability management process. The availability management is initiated by activating a menu key on the telephone which causes a list of menu options to be displayed on the telephone display screen. The user selects “PTT menu” from the list of options displayed on the screen, and a further list of options is provided from which the user selects “PTT settings.” A yet further list of options is provided from which the user selects “my availability.” A list of availability statuses is then displayed and the user can scroll to and select a desired availability status, for example “do not disturb.” The telephone then signals to the network the new availability status.

Thus, conventional approaches require a user to make multiple gestures in order to log in to the PTT application and establish a desired communications availability status other than the default status. In the aforementioned example, six user gestures are required to set a communications availability status other than the default status. Making multiple gestures is inconvenient and may be difficult, particularly if a handheld communications device such as a cellular telephone or smart phone is being used.

### SUMMARY

Aspects and embodiments of the present invention were devised with the foregoing in mind. For example, in a first aspect there is provided data processing apparatus that includes a processor, a memory, and a user interface. The data processing apparatus is configured to present to a user via the user interface a plurality of options, respective options indicative of a different state a user application operative on said data processing apparatus can have. In addition, it is configured to receive via the user interface a user selection of a one of the plurality of options. Further, it is configured to respond to the user selection to establish a user identity in said user application and to automatically set the state of the user application in accordance with the selected option.

In a second aspect there is provided a method of operating data processing apparatus for establishing a user identity in a user application operative on said data processing apparatus. The method comprises presenting to a user a plurality of options, respective options indicative of a different state the user application can have and receiving a user selection of a one of said plurality of options. In response to the user selection, the method also comprises establishing said user identity in the user application and automatically setting the state of the user application in accordance with the selected option.

Embodiments in accordance with the first and second aspects provide a mechanism for a user to establish themselves in, such as logging into, an application program with a reduced number of actions or so-called “gestures.” The user may not only login into an application but also set the state of the application at the same time. This eases a user's interaction with the application, for example, if the application is running on a handheld computing device.

In a particular embodiment a two stage process takes place in which responsive to a user selecting a state for the user application, the application first logs the user identity onto said user application. Such a process does not require modification of an application having a conventional login stage and then a set state stage, since the unitary stage of logging in and setting the state of the application as utilized by the user automatically implements the conventional login stage and then a set state stage unseen by the user.

Advantageously, the plurality of options may be generated in dependence on a state of the data processing apparatus. This may simplify, and therefore, enhance a user's interface experience since the options a user is presented with may be those relevant to the current state of the application. In particular, in a complex device a user may have set a state or states for other applications or purpose which is relevant to the use of the current application, and such state is reflected in the options presented to the user.

In a particular embodiment, the user application may comprise a communications application and the state of the user application comprises communications availability for said user identity. An example of a communications application utilizing communications availability states is a Push to Talk application. Optionally, or additionally, in particular for a communications application, a state of the user application is selectable from the group comprising: “available”; “silent mode”; and “do not disturb.”

Some devices which have audible alerts provide an audible alert switch, for example a ringer switch, which may be a physical electro-mechanical switch or a software selected item, which is switchable between an audible alert (“ring”) mode and a non-audible alert (“silent”) mode. For such devices, an embodiment of the invention may respond to the device in ring mode to present to the user only the application state options “available” and “do not disturb.” Optionally, or alternatively, an embodiment may respond to the device in silent mode to present to the user only the application state options “silent mode” and “do not disturb.”

In one embodiment, a mobile computing device is configured to include a wireless communications module. The wireless communication module may be configured for mobile (e.g., cellular or VOIP) telephony. In one embodiment, the mobile computing device may be structured in a handheld configuration. Examples of the mobile computing device include a personal digital assistant (PDA), smart phone (e.g., PDA type and/or entertainment/media type) a personal computer (PC) or a laptop. The wireless communication module may be hardware and/or software configured for mobile (e.g., cellular) telephony that is functionally integrated with the data processing apparatus. A further embodiment includes a set of machine-readable instruction elements operative in a data processing apparatus to implement embodiments described. The set of instructions may be in the form of a computer program, or part thereof, and is a particularly convenient way of distributing and implementing embodiments described herein.

Such sets of instructions are embodied in a carrier medium for storing and conveying the instructions to devices. A carrier medium may comprise one or more of the following: a memory, removable or non-removable media, erasable or non-erasable media, writeable or re-writeable media, digital or analogue media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, electronic or electrical signal, or radio frequency or optical carrier signal. All of which include media by which embodiments of the invention comprising a set of instructions may be distributed.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

Specific embodiments will now be described, by way of example only, with reference to the drawings, in which:

FIG. 1 is a schematic illustration of a PTT device and system;

FIG. 2 is a schematic illustration of an embodiment of a PTT device and system;

FIG. 3 is a schematic illustration of an embodiment of a communications device;

FIG. 4 is a process flow control diagram for an embodiment as described;

FIG. 5 is a schematic illustration of another embodiment of a PTT device and system; and

FIG. 6 is a process flow control diagram for another embodiment as described.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

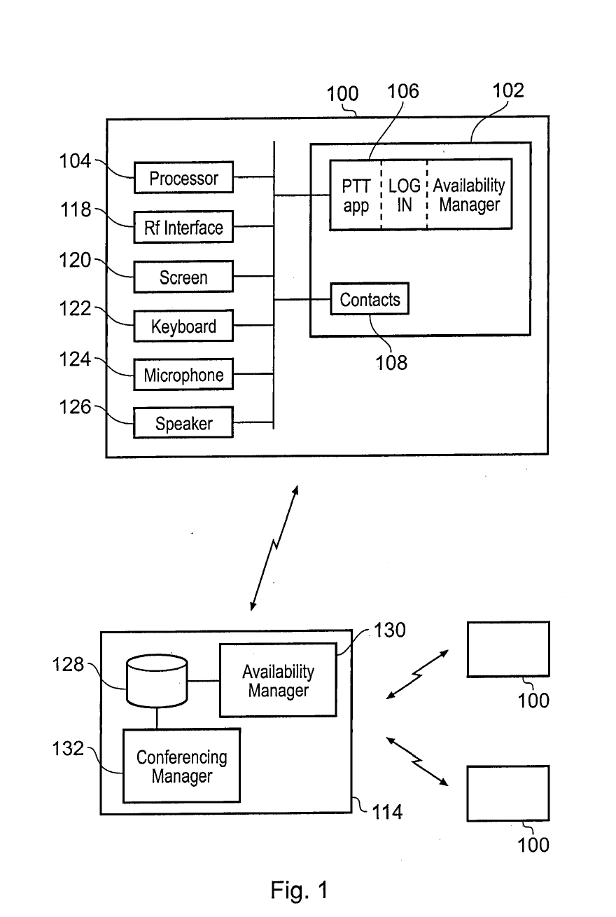

FIG. 1 illustrates a network that includes three communications devices 100, 100′, 100″ and a push to talk (PTT) exchange server 114. The PTT exchange server 114 is functionally and logically coupled to a communications network which may be a topological, cellular, PSTN, VOIP, or other suitable communications network.

The communications device 100 comprises computer memory 102, a processor 104, an RF interface 118, a screen 120, a keyboard 122, a microphone 124, a speaker 126, and data bus 101. Stored in computer memory 102 is a prior art push to talk (PTT) application program/module 106 and its associated contacts database 108. The PTT application 106 is configured to be run on processor 104. The contacts database 108 is configured to store the details of the contacts that are associated with each of the application programs 106 and 110.

The PTT exchange server 114 manages PTT users' availability and calls amongst one another. An example is made by Kodiak Networks of San Ramon, Calif. USA and was commissioned by Cingular Wireless. The PTT module 106 is made by Palm, Inc. of Sunnyvale, Calif. USA and also was commissioned by Cingular Wireless. The PTT exchange server 114 comprises a subscriber database 128, an availability manager 130 and a conferencing manager 132. The subscriber database 128 contains information about each of the users/subscribers to the PTT service with the PTT exchange server 114 including the presence status that has been recorded for each user. The availability manager 130 and conferencing manager 132 are logical modules that are configured to manage the availability of each of the users that use a PTT application through the PTT exchange server 114 and set up the PTT calls respectively. The system provides PTT functionality between a number of communications devices 100 having PTT application modules 106 via the PTT exchange server 114.

When a user of the communications device 100 wants to communicate with another user through one of the application programs 106, 110, they do so by selecting the user(s) they want to contact from the appropriate contacts database 108, 112. The user who initiates a call may be referenced as an “originator,” and the user that receives a call may be referenced as a “terminator.” A list of potential terminators is provided in, for example, a contacts list. In such context, reference to a “contact” may be as a potential terminator.

The screen 120 on the communications device 100 is configured to expose/display a list of contacts information sorted by a contacts name. The user of the communications device 100 can select a contact by their name using the keyboard 122. Further details associated with the contact, for example, their telephone number, fax number, email address, postal address and any other data that may be stored in association with the contact is retrieved from the relevant contacts database 108/112 and displayed on screen 120.

Push to talk application programs utilize what may be referenced as “presence” of a user. The “presence” is an indicator of availability that is stored in computer memory for a specific user, and is used to provide calling options to a calling party that can potentially call the user. A user of the push to talk application 106 can select one presence settings that are native to the PTT application, for example, ‘Available’, ‘Silent’ and ‘Do Not Disturb.’ A user also logs in to the PTT application when they wish to use PTT functionality, and log out of the PTT application when PTT functionality is no longer required.

After a user of the mobile communications device has logged in to the PTT application 106, the PTT application 106 causes three presence status options to be displayed on the screen 120. These are: available; silent; and do not disturb. After the user has selected one of the displayed status options using the keyboard 122, the selected status of the user is stored in the contacts database 108 in computer memory 102. The selected presence status is also sent to the PTT exchange server 114 via the RF interface 118.

Following receipt of the selected presence status at the PTT exchange server 114, the availability manager 130 causes the subscriber database 128 to be updated with the presence status of the user. In addition, the availability manager 130 sends data representative of the user's presence to each of the contacts' devices 100′, 100″ that have the user in their list of contacts. The contact's devices 100′, 100″ will cause their locally stored contacts lists to be updated with the new presence status information of the user. Furthermore, the availability manager 130 in the PTT exchange server 110 sends a confirmation message to the user's communications device 100 confirming that the presence status has been updated.

Similarly, when any one of the user's contacts updates their presence status, the PTT exchange server 114 receives a message from that contact's communications device 100′, 100″, which causes the PTT exchange server 114 to send a message to the user's communications device 100 providing information about the change of presence status for that one of the user's contacts. Following receipt of the change of presence status message from the PTT exchange server 114, the PTT application 106 causes the PTT contacts database 108 to be updated accordingly.

When a user wishes to set up a PTT call, they select an appropriate icon with the keyboard 122. The user may open a dedicated PTT application program to set up a call and select one or more contacts from a list of contacts with whom they wish to set up a PTT call. Optionally, the user may access a call log and set up the call by selecting the contact with whom he wishes to call directly from the call log. In a further option, a user may set up a call by responding to an alert, for example by responding to a prompt to “Call Tom” that is displayed to the user by a calendar application program. As can be seen, the user need not necessarily initiate a call set up directly through the PTT application, and other forms of call initiation may be implemented in embodiments of the invention.

When the PTT application 106 receives an instruction that a PTT call is to be set up for a selected one or more contacts, the PTT application extracts the PTT contacts information corresponding to the selected one or more contacts from PTT contacts database 108 and generates a dial string. The dial string includes an identifier of the PTT exchange server 114 that will set up the PTT call, a caller identifier, and an identifier of the one or more contacts that the user wishes to contact. The PTT application 106 then sends the dial string to the PTT exchange server 114 via the RF interface 118 in the user's communications device 100. The user's communications device 100 is now an originating communications device.

Following receipt of the dial string, the conferencing manager 132 in the PTT exchange server 114 uses the identifier of each of the one or more contacts to look up the telephone numbers of the one or more contacts in the subscriber database 128. The conferencing manager 132 then generates a second dial string that includes an indicator that a PTT call is being requested, and an identifier of the user that is requesting the call. The PTT exchange server then sends the dial string to the telephone numbers of the one or more contacts—that is the terminating devices.

How a terminating communications device 100′, 100″ processes the incoming dial string from the PTT exchange server 114 depends upon the presence status of the contact that is stored in computer memory of the terminating communications device 100′, 100.″ The user of the terminating communications device will have already recorded their intended presence setting in computer memory as discussed above.

If the contact is recorded as “logged in and available” in the availability manager on the PTT server 114, the call is set up and routed to the called terminating communications device 106′/106.″ If the contact is recorded as “logged in and silent,” the PTT application within the terminating communications device 100′, 100″ causes the user of the terminating communications device 100′, 100″ to be presented with an option as to whether or not they would like to accept the call. If the user of the terminating communications device provides an indication that they want to accept the call, the PTT application sends a message to the PTT exchange server 114 that indicates that the call is accepted, and the call is set up. If the user of the terminating communications device 100′, 100″ provides an indication that they want to reject the call, the PTT application sends a message to the PTT exchange server 114 that indicates that the call is rejected, and the call is not set up.

If the contact is recorded as “logged in and do not disturb” in the availability manager on the PTT server 114 automatically responds by rejecting the call, and this occurs without any action or knowledge of the user of the called terminating communications device 100′, 100.″ Optionally, a call log in the PTT server may record that a call was rejected.

In a PTT call, when one of the users of the devices is speaking they are said to “have the floor,” and the PTT application allows only one user to have the floor at any one time. When nobody has the floor, a user can “take the floor” by pressing their “push to talk” button. If the floor is successfully gained, the user's communications device makes a “chirp” sound as confirmation and the user's speech is transmitted to the other communications devices. If the floor is not successfully gained, for example if another user has got there first, the user's communications device makes a “bong” sound and the user knows that they do not have the floor. If the user does not have the floor, their speech is not transmitted to the other communications devices.

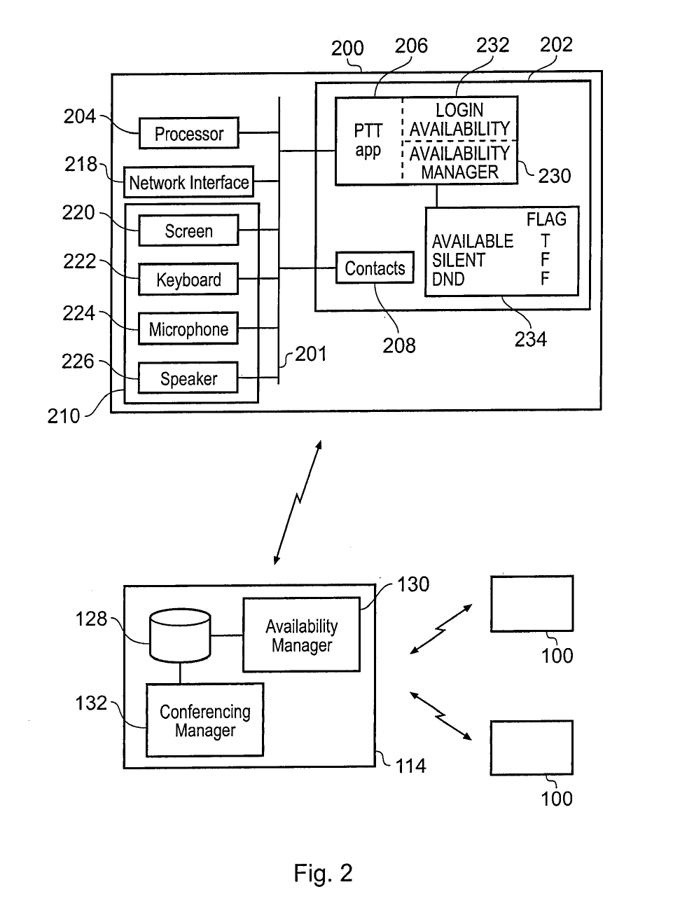

FIG. 2 illustrates an embodiment of a data processing apparatus configured as a communications device 200. Communications device 200 comprises a computer memory 202, processor 204, network interface 218, speaker 226, and data bus 201 and a user interface 210 including a display screen 220 which may be a touch sensitive screen, a keyboard/keypad 222, and a microphone 224. A PTT application program 206 is stored on computer memory 202 and is configured to be run on processor 204. In accordance with one embodiment, application program 206 includes a communications availability manager 230 and a login availability module 232.

The communications availability manager 230 manages the communications availability status for the communications device 200 as input by the user. When the availability manager 230 receives an indication that the user wants to set their availability status, the availability manager 230 displays on screen 220 a list of the potential availability statuses that the user can record themselves as having. The communications availability manager 230 includes an availability status register 234 formed in a portion of memory 202. Once availability status has been selected by a user, the communications availability manager 230 stores that status in a memory location, which in the described embodiment is by setting a corresponding flag in the availability register 234. The communications availability manager 230 then sends a notification of the communications availability status to availability manager 130 in the PTT exchange server 114.

Login availability module 232 interfaces with communications availability manager 230 to provide to a user of communications device 200 a list of availability options at the time of logging in to the PTT application 206. The user of communications device 200 may select a communications availability option at the time of login, and the login availability manager 232 indicates the selection to the availability manager 230.

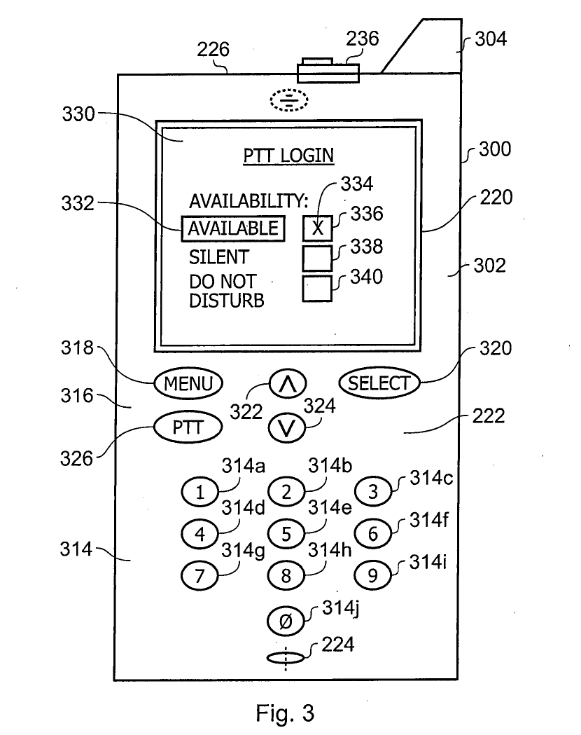

Referring now to FIG. 3, it illustrates a schematic representation of an embodiment configured as a cellular telephone 300. The cellular telephone 300 includes a housing 302 which houses various processing resources and interface elements such as included in data processing apparatus 200 illustrated in FIG. 2.

Cellular telephone 300 also includes an RF antenna 304 for providing an interface to a cellular telephone network, a display screen 220, a keyboard 222, a speaker 226 and a microphone 224. The keyboard 222 includes a numeric keypad 314, comprising dial buttons 314a to 314j; and menu/function keys 316 comprising a menu key 318, a “select” key 320, up/down keys 322/324 and a “PTT” key 326 for initiating PTT application 206.

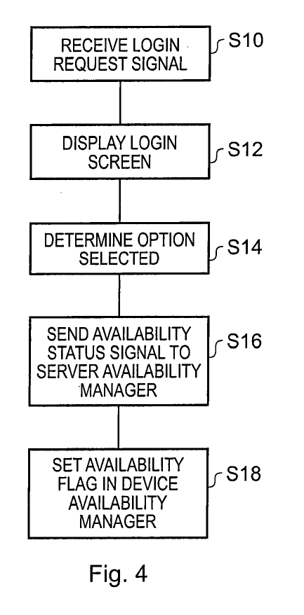

Next, referring to FIG. 4, it illustrates an embodiment of a process flow for login availability module 232. Responsive to user actuation of “PTT” key 326 a key actuation signal is generated and sent across bus 201 to processor 204 which generates and sends a PTT login request signal to login availability module 232. The login availability module 232 receives the PTT login request signal, step S10, and responds by causing a display login screen, 330, to be displayed on screen 220, step S12.

The PTT login screen display 330 includes a list of communications availability options, which in the currently described embodiment comprise: “available”; “silent”; and “do not disturb.” A user may highlight an option and move the highlighting between options by actuating up/down keys 322/324. A highlighted option may be selected by actuation of “select” key 320. Optionally, a “check” indicia 334 may be moved between selection boxes 336 to 341 for example a one of “up/down” keys 222/224. In an embodiment comprising a touch sensitive screen 220, touching an option or corresponding selection box may cause highlighting of the option or checking of the corresponding box. Selection is confirmed by actuation of the “select” key. Optionally it may be confirmed by touching a displayed option or checking the corresponding check box.

Responsive to a user actuating “select” key 320 a “select” key signal is sent from the keypad across data bus 201 to login availability module 232 running on processor 204. Similarly, in an embodiment utilizing a touch sensitive screen, when a user touches a part of the screen displaying an option or corresponding to a selection box a signal indicative of that part of the screen that has been touched is sent from the touch screen display 326 to the login availability module 232 running on processor 204.

Login availability module 232 recognizes that a “select” key has been activated and determines which option has been highlighted or checked, S14. In the touch screen embodiment, login availability module 232 determines which displayed option corresponds to that part of the screen that has been touched.

Login availability module 232 forms an availability status signal which it sends over RF interface 318 to the PTT exchange server 114, to indicate the new availability status, S16. Furthermore, server 114 also sends a signal representative of the new availability status of the user to each of the user's contacts for each of the application programs.

Additionally, login availability module 232 instructs the device availability manager 232 to set the availability flag corresponding to the new availability status as true in the availability register 234. In the embodiment illustrated in FIG. 2, the availability status flag has been set “true” for the “available” status.

As is evident to the person of ordinary skill in the art from the foregoing, an embodiment in accordance with the present invention requires only two steps, sometimes referred to as “gestures,” to log in to the PTT application, and this compares favorably with the six steps required for establishing a communications availability status in the prior art system.

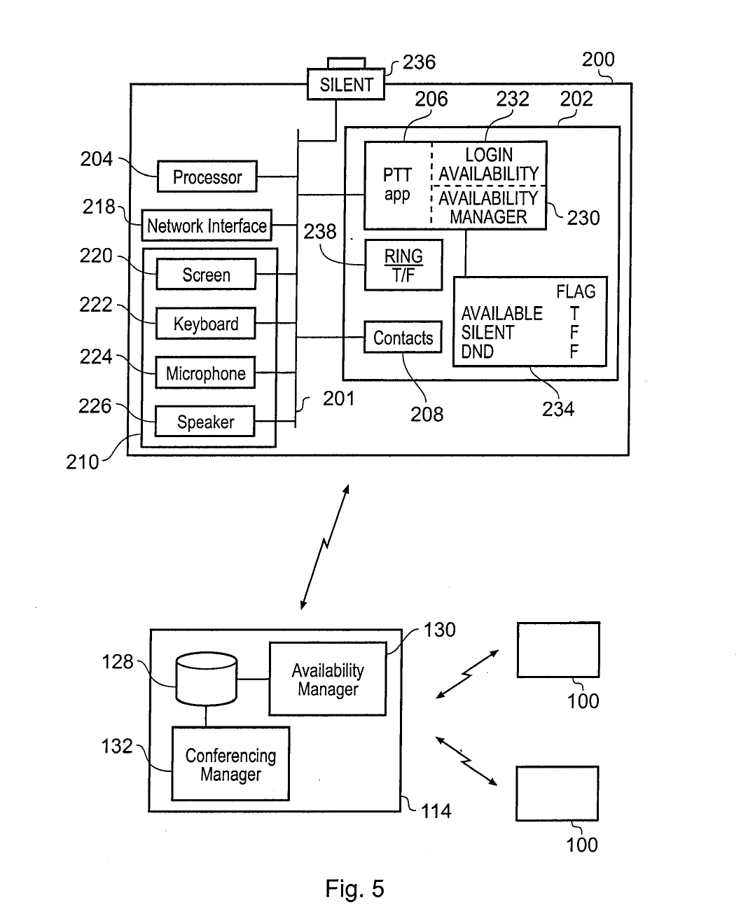

In another embodiment schematically illustrated in FIG. 5, data processing apparatus 200 includes an electromechanical switch to 236. Typically, switch 236 is located in a housing of the data processing apparatus, for example housing 302 when the data processing apparatus is configured as a cellular telephone such as that illustrated in FIG. 3.

Switch 226 is movable between a first position indicative that the ringer is silent and a second position indicative that the ringer is not silent. Switch 236 is coupled to a processor 204, for example data bus 201, which determines whether the switch is in its first or second position. Depending upon whether the processor 204 determines that the switch is in its first or second position a signal is sent to an alert module 238 comprising a “ring” register to set the status of “ring” flag “false” or “true.” The “ring” register 238 status is set to “false” for switch 236 being in its first position, and “true” for switch 236 being in its second position.

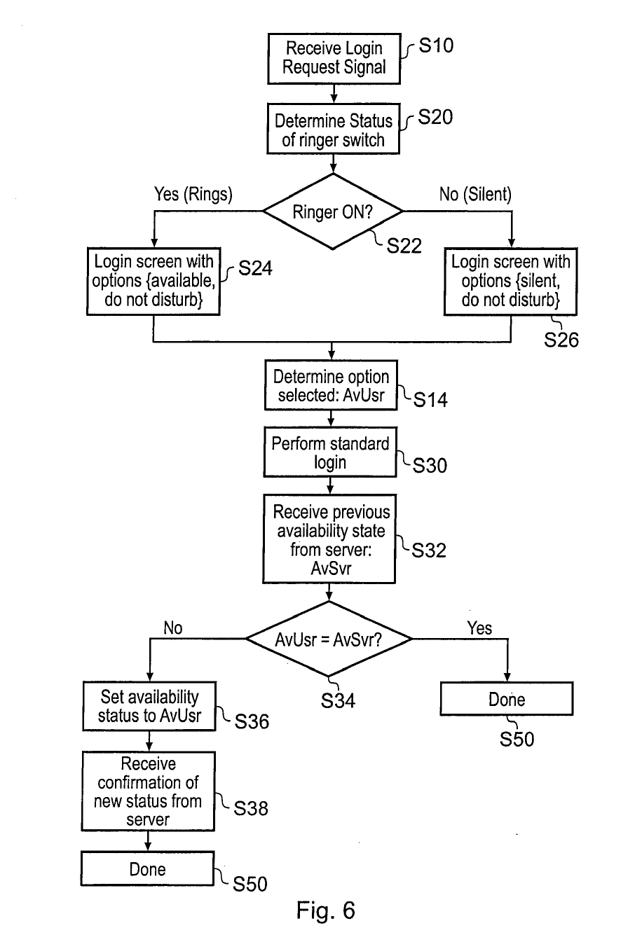

A process control flow diagram is illustrated in FIG. 6 for the operation of a data processing apparatus in accordance with the second embodiment of the invention. As for the first embodiment described above, a login request signal is received by login availability module 232, S10. However, for the second embodiment the login availability module 232 responds to receiving login request signal by determining the status of the “ringer” switch, S20, by interrogating the status of “ring” flag in the alert module 238.

If the status of the “ring” flag is true, that is to say the “ringer” switch status is not silent, S22, process control flows to step S24 where a login screen with “available” and “do not disturb” options is displayed. Otherwise, for the “ring” flag being set to “false” process control flows to step S26 where a login screen is displayed giving options which are consistent with are ringer switch set to “silent.” An example of such a login screen is one in which just the options “silent” and “do not disturb” are provided.

Process control flow includes a step S14 where it is determined which option has been selected, for example, as described with respect to FIG. 4. At step S30 a conventional log in process is performed, but “hidden” from the user in that it takes place automatically. At step S32 the data processing apparatus retrieves the previous availability state from the availability manager 130 on server 114. If the state now in the availability manager 230 in the data processing apparatus is the same as that in the availability manager 130 on the server 114, S34, then the process halts, S50.

The process also includes determining if the ringer switch has been altered again while the process was occurring. If availability status in the data processing apparatus is “available” and the ringer was turned off at step S34, the data processing apparatus status is changed to “silent.” Similarly, if availability status in the data processing apparatus is “silent” and the ringer is turned on at step S34, is changed to “available.” However, if the data processing apparatus status is “do not disturb” the status will not be modified if ringer switch is changed at S34.

Otherwise, updating the server availability manager and setting the availability flag in the device availability manager occurs at steps S16 and S18, for example, as described with respect to FIG. 4. Namely, the status set in the availability manager 232 on the data processing apparatus is sent to the server 114, S36. Once confirmation has been received by the data processing device of the new status from the server, S38 the process halts, S50.

In view of the foregoing description it will be evident to a person skilled in the art that various modifications may be made within the scope of the invention. For example, embodiments of the present invention need not be limited to PTT applications or devices, but may include other applications such as MSN messenger. The MSN Messenger instant messaging application program also utilizes a communications availability status of the user and the user's contacts, and allows instant text messages to be sent from a user to one or more recipients over the internet. The user's MSN Messaging contacts could be stored in a contacts database in the same memory as PTT application contacts database 108. Once a user has logged in to MSN Messenger, they can set their availability as one of the following: Online; Busy; Be Right Back; Away; In a Call; Out to Lunch; Appear Offline.

Other communication applications may also be utilized in embodiments of the present invention, together with non-communications applications such as a calendar or scheduler application, where the availability of a user may be recorded. In addition, ringer switch 236 need not be an electro-mechanical switch but whether or not the ringer is silent may be a menu option set by a user through the screen display of the apparatus.

The various elements of the described embodiments such as the availability manager and login availability module may comprise parts which are distributed throughout the PTT application, and run on different processors or at different times. As such, the elements may be considered to be “logical modules” having a particular function or functions, but not necessarily located in the same place. Note that FIG. 6 also illustrates an embodiment of a process for the operation of checking and establishing availability status in the second embodiment, (i.e. S30 to S34), for example, with the embodiment described with reference to FIG. 4.

Insofar as embodiments described above are configurable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, various types of Digital Versatile Disk (DVD) subscriber identify module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise

The scope of the present disclosure includes any novel feature or combination of features disclosed therein either explicitly or implicitly or any generalization there irrespective of whether or not it relates to the claimed invention or mitigate any or all problems addressed by it. The applicant hereby gives notice that the claims may be formulated to such features during the prosecution of this application and any such further application derived therefrom. In particular, with reference to dependent claims, features from dependent claims may be combined with those of the independent claims and features from respective independent claims may be combined in any appropriate manner and not merely in the specific combinations enumerated in the claims.

What is claimed is:

1. A method of establishing a user identity in a user application operative on a data processing apparatus, the method comprising:
presenting to a user a plurality of options, each option corresponding to a different state applicable to said user application;
receiving a user selection of a one of said plurality of options; and
responsive to said user selection establishing said user identity in said user application, automatically setting the state of said user application in accordance with the said selected option.

2. The method of claim 1, further comprising launching of said user application responsive to user initiation of said user application prior to presenting to a user said plurality of options.

3. The method of claim 1, responsive to said user selection to initially log said user identity onto said user application.

4. The method of claim 1, further comprising generating said plurality of options in dependence on a state of said data processing apparatus.

5. The method of claim 1, said user application comprising a communications application and wherein said state of said user application comprises a communications availability for said user identity.

6. The method of claim 5, wherein said communications application is a push to talk application.

7. The method of claim 5, wherein a state of said user application is selectable from: available; silent mode; or do not disturb.

8. The method of claim 7, operative in a communications device switchable between an audible alert mode and a silent non-audible alert mode, the method further comprising responding to said device in audible alert mode to present to said user only application state options available and do not disturb.

9. The method of claim 7, operative in a communications device switchable between an audible alert mode and a silent non-audible alert mode, further comprising responding to said device in non-audible alert mode to present to said user only application state options non-audible alert mode and do not disturb.

10. A data processing apparatus, comprising:
a processor;
a memory; and
a user interface;
said data processing apparatus configured to:
present to a user via said user interface a plurality of options, the plurality of options corresponding to a different state available for a user application operative through the processor on said data processing apparatus;
receive via said user interface a user selection of a one of said plurality of options; and
respond to said user selection to establish a user identity in said user application and to automatically set the state of said user application in accordance with the said selected option.

11. The data processing apparatus of claim 10, further configured to present to a user said plurality of options following the launch of said user application responsive to user initiation of said user application.

12. The data processing apparatus of claim 11, configured to respond to said user selection to firstly log said user identity onto said user application.

13. The data processing apparatus of claim 11, responsive to a state of said data processing apparatus to generate said plurality of options in dependence on said state.

14. The data processing apparatus of claim 13, wherein said user application comprises a communications application and said state of said user application comprises a communications availability for said user identity.

15. The data processing apparatus of claim 14, wherein said communications application is a push to talk application.

16. The data processing apparatus of claim 15, wherein a state of said communications application is selectable from: available; silent mode; or do not disturb.

17. The data processing apparatus of claim 15, configured to be switchable between an audible alert mode and a non-audible alert mode and operative in said audible alert mode to present to said user application state options available and non-audible alert mode.

18. The data processing apparatus of claim 15, configured to be switchable between an audible alert mode and a non-audible alert mode and operative in said non-audible alert mode to present to said user application state options non-audible alert and “do not disturb.”

19. The data processing apparatus of claim 15, wherein the data processing apparatus comprises a mobile computing device.

20. The data processing apparatus of claim 19, wherein the mobile computing device further comprising a wireless communications module.

21. The data processing apparatus of claim 20, wherein the wireless communications module comprises a telephony module.

22. A computer readable medium structured to store instructions executable by a processor, the instructions to establish a user identity in a user application operative on the processor, the instructions when executed by the processor cause the processor to:
present to a user a plurality of options, each option corresponding to a different state applicable to said user application;
receive a user selection of a one of said plurality of options; and
responsive to said user selection to establish said user identity in said user application, automatically set the state of said user application in accordance with the said selected option.

23. The computer readable medium of claim 22, wherein the instructions further cause the processor to execute said user application responsive to user initiation of said user application prior to executing instructions to present to a user said plurality of options.

24. The computer readable medium of claim 22, wherein the instructions further cause the processor to generate said plurality of options in dependence on a state of said data processing apparatus.
